(19) United States
(12) Patent Application Publication
(10) Pub. No.: US 2014/0072157 A1
(43) Pub. Date: Mar. 13, 2014

(54) MAGNETIC CONNECTOR

(71) Applicant: Oticon A/S, Smorum (DK)

(72) Inventors: Svend Oscar PETERSEN, Smorum (DK); Bent SEVERIN, Smorum (DK)

(73) Assignee: Oticon A/S, Smorum (DK)

(21) Appl. No.: 13/965,865

(22) Filed: Aug. 13, 2013

Related U.S. Application Data
(60) Provisional application No. 61/699,306, filed on Sep. 11, 2012.

(30) Foreign Application Priority Data
Sep. 11, 2012 (EP) 12183817.1

(51) Int. Cl. H04R 25/00

(52) U.S. Cl. CPC H04R 25/65
USPC 381/330; 181/224

(57) ABSTRACT

Acoustic duct connector for an acoustic duct of the type being used for real ear measurements, the acoustic duct connector comprising a first surface portion and a first acoustic duct exiting from said first surface portion, and comprising a first magnetical component for engaging to a second magnetical component comprised by a receiving connector such, that an airborne sound signal can propagate from the first acoustic duct to a second acoustic duct exiting from a second surface portion of the receiving connector when the acoustic duct connector and the receiving connector are connected to each other.

### BACKGROUND OF THE INVENTION

The invention is related to hearing aids, more specifically to a connector for coupling an acoustic duct of the type being used for transmitting an airborne sound to or from a hearing aid or measurement instrument. The invention is also related to an acoustic tube coupling comprising such a connector.

In audiology real ear measurements (REM) are performed to verify the acoustical properties of the sound which a hearing aid actually presents to a user. One of the acoustical properties is the Real Ear to Coupler Difference (RECD), which in existing setups can be measured using the hearing aid itself. To do so it is required to attach an acoustic duct to a (BTE)-hearing aid's microphone, place a probe microphone in the ear canal, place a mould in the ear canal next to the acoustic duct and finally place the hearing aid behind the ear—or alternatively—to place the hearing aid behind an ear first, then the acoustic duct in the ear canal and finally the mould in the ear canal.

An adapter for coupling an acoustic duct for REM to a microphone of a hearing aid is known wherein the adapter comprises a sleeve adapted to be arranged around the housing of a hearing aid, wherein the sleeve has a sound opening allowing sound to pass from the acoustic duct to the microphone.

An attachment device for a probe microphone is also known, wherein the attachment device comprises two magnetical holding members one of which is to be disposed at a user's ear lobe while the other is uses to slide a probe microphone into an optimal position.

A neckloop with a magnetic clasp for a teleloop hearing aid system is discloses in EP 2 222 095 A1. The magnetic clasp is plated so as to allow an electrical conductivity of said clasp.

DE utility model DE 201 14 121 U1 discloses a hearing aid with a BTE part and an in the ear mould and comprising a tube from the BTE part to the mould part where a magnet coupling is suggested between tube end belong to each part respectively wherein an external conically shaped male tube end is to be inserted into an internal conically shaped female tube end to provide the tube connection. If the tube ends are not mutually aligned and oriented with respect to the axis of the two conical tube ends, the interconnection cannot be successfully concluded.

It is a technical object of the present invention to provide a sound duct connector for coupling a sound duct to a hearing aid or probing device which is simple and reliable.

### SUMMARY OF THE INVENTION

According to a first aspect of the present invention the object is achieved by an acoustical duct connector, comprising a first surface portion and a first acoustic duct exiting from said first surface portion, and comprising a first magnetical component for engaging a second magnetical component comprised by a receiving connector, such that an airborne sound signal can propagate from the first acoustic duct to a second acoustic duct exiting from a second surface portion of the receiving connector when the connector is connected to a corresponding receiving connector.

The present invention includes the recognition that RECD measuring setups according to prior art are complicated as it is—on one hand—difficult to place an acoustic duct in the ear canal while it is attached to a hearing aid or measuring unit and—on the other hand—difficult to connect the acoustic duct to the hearing aid or measuring unit sitting on or at the ear, as both ways require use of two hands and a significant amount of force so as to connect a usually soft acoustic duct to a connector on the hearing aid or measuring unit.

With the sound duct connector according to the first aspect of the present invention, it is possible to connect and release a sound duct such as an acoustic duct in a very simple manner using only one hand. Thus the sound duct connector also provides for a tight coupling between an acoustic duct and a microphone, closing of interferences from ambient sound sources and allowing propagation of sound signals across the coupling with little or no loss. Such a sound duct connector is especially suitable and safe for fine-tuning hearing aids to children, as here the volume between receiver outlet and tympanic membrane is small and thus may have decisive influence on the magnitude of the sounds reaching the tympanic membrane.

According to a second aspect of the present invention the object is achieved by an acoustical duct coupling, comprising a connector with a first surface portion and a first acoustic duct exiting from said first surface portion, and a receiving connector with a second surface portion and a second acoustic duct exiting from said second surface portion, wherein the sound duct connector comprises a first magnetical component for engaging to a second magnetical component comprised by the receiving connector, such that an airborne sound signal can propagate between the first and the second acoustic ducts when the acoustical duct connector and the receiving connector are connected to each other.

In the following, embodiments of the acoustical duct coupling of the second aspect of the present invention as well as embodiments of the acoustic duct connector of the first aspect of the present invention are described. Additional features elucidated in the context of different embodiments can be combined with each other to form further embodiments of the acoustic duct coupling of second aspect of the present invention as well as the acoustic duct connector of the first aspect of the present invention, as long as they are not explicitly described as forming mutually exclusive alternatives to each other.

In an embodiment, to provide a very compact magnetical connection, the first surface portion is that of the first magnetical component. The first surface portion is entirely constituted by a surface portion of the first magnetical component. Accordingly the second surface portion of the receiving connector can be that of the second magnetical component.

Alternatively, to allow for custom installations, the first magnetical component can be located next to the first acoustic duct and/or the second magnetical component is located next to the second acoustic duct. In a further embodiment more first and second magnetical components can be arranged next to a respective acoustic duct.

The first and the second surface portion can have congruent annular cross sections. The annular cross sections can be coaxially aligned with the respective acoustic ducts. The first acoustic duct can be formed by a through hole that is defined by the annular cross section of the first surface portion. Accordingly the second acoustic duct can be formed by the through hole defined by the annular cross section of the second surface portion. In this manner a connection with a high operating safety is provided since the respective connectors can be brought together at an arbitrary rotational angle with respect to each other.

Alternatively, to provide a connection with a higher degree of freedom, the first surface portion can be of a concave, e. g. calotte shape and the second surface portion of a convex, e. g. spherical shape complementary to the calotte shape and vice versa. In this manner the acoustic duct connector and the receiving connector can be rotated against each other. The acoustic duct exiting from a spherically shaped surface portion can comprise a recess so as to provide for minimum effective cross section if the acoustic duct connector and the receiving connector are rotated against each other.

The first and the second magnetical component can be provided in several ways. For instance, both the first and the second magnetical component can be permanently magnetized. Alternatively the first magnetical component can be permanently magnetized and the second magnetical components are non-magnetized, or vice versa. If, for example, the second magnetical component is to be integrated in a housing of a hearing aid it might be required to provide it non-magnetized to prevent interference with another hearing aid component.

To ensure a correct coupling, the first and the second magnetical component may be magnetized axially with respect to an axis normal to the respective first and second surface portion. Thereby the connectors will either attract or repel each other independent of the rotational angle they are brought together at. If, for example, a first axially magnetized receiving connector is disposed around a microphone inlet of an audiometric apparatus and a second receiving connector of an opposite axial magnetization is disposed around a speaker outlet of said apparatus, an acoustic duct connector having axially magnetized first magnetical component will connect to only either the first or the second receiving connector.

Alternatively, the first and the second magnetical component can be permanently magnetized diametrically with respect to an axis normal to their respective first and second surface portion. In this manner a magnetical component can be mounted without a preferred direction which simplifies connector production.

In an embodiment, to ease handling and prevent debris from entering the duct, the acoustic duct connector and/or the receiving connector comprises a housing circumferentially enclosing the first magnetical component. Preferably, the housing defines a mechanical interface adapted to connect to an acoustic duct. A connection of the mechanical interface can be of friction fitting type, for example an outer diameter of an acoustic duct being fitted to an inner diameter of the housing, or vice versa. A connection of the mechanical interface can also be established by fusing an acoustic duct to a housing of a connector. Alternatively or optionally an acoustic duct can be friction fitted or fused to a magnetical component directly.

In a further embodiment the first surface portion and/or the second surface portion are smooth or covered with a respective sealing member so as to shield an airborne sound signal propagating from an acoustic duct into an acoustic duct of a receiving connector from the acoustic environment. The sealing member can be a coating. The coating constituting the sealing member can be such that a respective sealing member extends around the first and/or the second magnetical component. Preferably, the acoustic duct connector and/or the receiving connector comprise a respective sealing member, wherein a first sealing member is located on the first surface portion and next to the first magnetical component and a second sealing member is located on the second surface portion and next to the second magnetical component. By providing such sealing a connection between an acoustic duct connector and a receiving connector, can be considered acoustically tight from 100 Hz and above, that is less than 1 dB drop in SPL (sound pressure level) at 100 Hz compared to 100% air tight. A sealing member can be made of a sealing material such as rubber, nylon, silicone of similar soft material.

Whether a sealing member is provided or not, the smooth surface portion may extend along a geometric plane to intersect the sides of the housing, said plane being arranged perpendicular to the sound duct. In this way the surface portions may approach each other either sideways or axially relative to the sound ducts and in both cases the sound ducts will be sure to end up in alignment with each other. Also if the housings are not well aligned axially or tilted with respect to each other when the two housings are approached to each other, the plane surfaces and the magnets therein will ensure near perfect alignment of the sound ducts.

The acoustic duct connector may comprise a first guiding member located at the first surface portion and/or the receiving connector may comprises a second guiding member located at the second surface portion. The guiding members match each other. The guiding members can be provided as complementary bevelled rims arranged around their respective surface portions. Advantageously such guide members prevent misalignment of an acoustic duct connector and a receiving connector in the process of connecting and securing the alignment in the state of connection. Furthermore such guiding members can enhance a seal between an acoustic duct connector and a receiving connector. Guiding can also be achieved by providing the first magnetical component having a calotte shape and the second magnetical component having a spherical shape complementary to the calotte shape or vice versa.

To provide for a first acoustic duct to be extended with a second acoustic duct, the acoustic duct connector may be connected to a first acoustic duct and/or the receiving connector may be connected to a second acoustic duct.

The receiving connector can be arranged around an acoustic inlet of a hearing aid adapter. The hearing aid adapter can comprise a sleeve adapted to be wrapped around a housing of a hearing aid, wherein the acoustic inlet is disposed in the sleeve so as to connect to a microphone inlet of the hearing aid. In this way the capability of receiving an acoustic duct connector can be provided for a hearing aid of arbitrary make.

The receiving connector may be arranged around a microphone inlet and/or a receiver outlet of a hearing aid directly. In this manner an acoustic duct having an acoustic duct connector can be connected to the hearing air without requiring any further adapter.

The receiving connector may be arranged around a microphone inlet of a RECD-measuring component (RECD: “Real Ear to Coupler Difference”). This allow for an airborne sound entering the second acoustic duct of the receiving connector to propagate to a RECD-measuring component's internal microphone, providing a very convenient way of performing RECD measurements. The RECD-measuring component itself is preferably adapted to be releasably connected to a hearing aid by way of a usual mechanical and electrical interface, and also the RECD-measuring unit may have means for connection to a programming unit such as a computer or dedicated programming electronic device.

According to a further aspect of the present invention the object is achieved by an acoustic duct assembly, comprising an acoustic duct of the type being used for real ear measurements and an acoustic duct connector according to the first aspect of the present invention attached thereto. The features described previously can be added to the acoustic duct coupling as disclosed to form further embodiments.

The magnetic connection is a great advantage in use with probe tubes used for real ear measurements. In general it is a difficult to connect a real ear measurement probe tube to the real ear measurement system, and the magnetic connection makes it possible to do this with one hand only. The acoustical duct used as probe tube is characterized by being a thin flexible tube that can be placed in the ear canal, either alone or next to an ear mould, foam plug or similar element.

The inner diameter of the probe tube needs to be minimum 0.45 mm to minimize the acoustical loss in the tube and the outer diameter needs to be below 1.20 mm to ensure that the probe tube can fit between an ear mould and the ear canal without too much acoustical leakage.

The length of a probe tube has to be at least 40 mm to be long enough to reach into an ear canal and not longer than 250 mm to avoid too much acoustical loss in the tube.

The material of the probe tube needs to be soft in order to both be flexible enough to place in the ear canal and comfortable for the user. To ensure this the shore A value of the material should be between 55 and 90. Examples of suitable materials for the probe tube could be silicone or a nylon blend. The tube needs to be easily bended and flexible, and in case a thin walled tube is used, a harder material may work fine. If a thicker wall is chosen for the tube a shore value in the lower range must be used to obtain the needed bendability. Also in these considerations it must be ensured that the tube is not prone to collapse, which would block the sound propagation within the tube.

In order to both hold a magnet in place and to create a good seal in the surface of the magnetic connection, it is an advantage to mould the magnet/magnets used in the magnetic connection in a soft material. The material can be silicone or a nylon blend. The soft material ensures a good acoustical seal even if a human hair is caught between the two connecting surfaces. The thickness of the soft material on the connecting side of the magnet shall be larger than 0.20 mm to ensure a seal and lower than 0.8 mm to ensure a high magnetic force.

In the magnetic connection it is an advantage to have a plan surface between the two connecting units. In the combination with the magnetic connection concept with two magnets (one in each connecting unit) this will ensure a better orientation and positioning of the two units. This can be used with either hard or soft connecting surfaces.

According to a further aspect of the invention the object is achieved by a hearing aid adapter for coupling an acoustic duct to a microphone inlet of a BTE-hearing aid, the hearing aid adapter comprising a sleeve adapted to be arranged around a housing of a BTE-hearing aid and further comprising a receiving connector as previously described.

According to a further aspect of the invention the object is achieved by a RECD-measuring component adapted to be releasably connected to a housing of a BTE-hearing aid, the RECD-measuring component comprising a receiving connector as described, and further comprises a microphone, wherein the receiving connector is acoustically connected to the microphone so as to allow for an airborne sound signal entering the receiving connector to propagate to the microphone.

According to a further aspect of the present invention the object is achieved by a BTE-hearing aid comprising a housing having a microphone inlet, and comprising a hook having a receiver outlet, wherein the BTE-hearing aid further comprises a receiving connector as described with respect to the second aspect of the invention, the receiving connector being arranged around the microphone inlet and/or the receiver outlet BTE-hearing aid.

### BRIEF DESCRIPTION OF THE DRAWINGS

These and other aspects of the invention will be apparent from and elucidated with reference to the embodiments hereinafter. In the following showing schematically:

FIG. 1 an acoustic duct connector together with a receiving connector;

FIG. 2 a perspective view of an acoustic duct connector;

FIG. 3 an acoustic duct connector together with a receiving connector;

FIG. 4 an acoustic duct assembly;

FIG. 5 an acoustic duct coupling with annular magnetical components;

FIG. 6 an acoustic duct coupling with magnetical components next to the acoustic ducts;

FIG. 7 an acoustic duct coupling with magnetical components axially magnetized;

FIG. 8 an acoustic duct coupling with magnetical components radially magnetized;

FIG. 9 an acoustic duct coupling with the magnetical components proving a sealing;

FIG. 10 an acoustic duct coupling with the magnetical components coated;

FIG. 10a an acoustic duct coupling with the magnet, tube and overmould;

FIG. 11 an acoustic duct coupling with a sealing next to the magnetical components;

FIG. 12 two magnetical components with a calotte/spherical shape;

FIG. 13 a hearing aid adapter together with a BTE-hearing aid;

FIG. 14 a RECD-programming component together with a BTE-hearing aid;

FIG. 15 a BTE-hearing aid having a receiving connector;

FIGS. 16A and 16B an internal view of a RECD-programming component and an acoustic duct assembly;

FIGS. 17A and 17B an external view of a RECD-programming component and an acoustic duct assembly;

FIG. 18 a BTE hearing aid is shown with a sound duct connector mounted at the receiver output part;

FIG. 19 is a RECD device on an ear and in a coupler measuring unit and

FIG. 20 shows a schematic representation of a RECD measuring unit.

### DETAILED DESCRIPTION

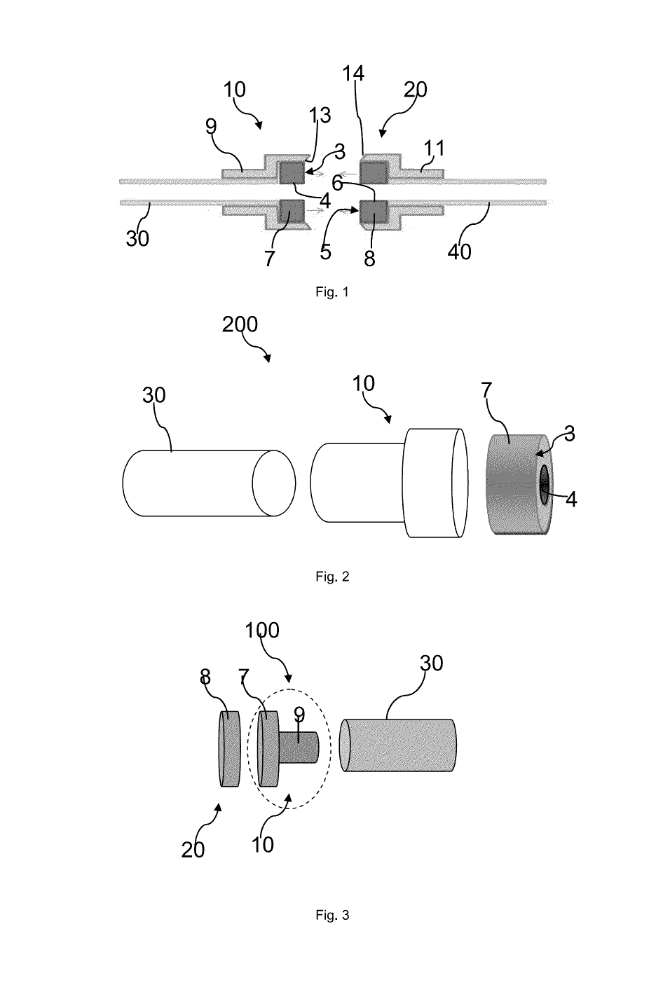

Depicted on the left side of FIG. 1 is an acoustic duct connector 10 connected to a first acoustic duct 30. The acoustic duct connector 10 comprises a first surface portion 3 and a first acoustic duct 4 exiting from said first surface portion 3. The first surface portion 3 is a surface of a first magnetical component 7 comprised by acoustic duct connector 10.

Accordingly the right side of FIG. 1 shows a receiving connector 20 connected to a second acoustic duct 40. The receiving connector 20 comprises a second surface portion 5 and a second acoustic duct 6 exiting from said second surface portion 5. The second surface portion 5 is a surface of a second magnetical component 8 comprised by receiving connector 20.

The first and the second surface portion 3, 5 have congruent annular cross sections coaxially aligned with their respective acoustic ducts 4, 6. The acoustic duct connector 10 comprises a housing 9 circumferentially enclosing the first magnetical component 7 and the receiving connector 20 comprises a housing 11 circumferentially enclosing the second magnetical component 8.

The acoustic duct connector 10 comprises a first guiding member 13 located at the first surface portion 3 and the receiving connector 20 comprises a second guiding member 14 located at the second surface portion 5. The guiding members 13, 14 are shaped as complementary bevelled rims arranged around their respective surface portions 3, 5.

It can also be seen from FIG. 1 that the outer diameter of the first acoustic duct 30 is fitted to the inner diameter of the first housing 9. Accordingly the second acoustic duct 40 has an outer diameter fitted to the inner diameter of the second housing 11.

FIG. 2 shows an acoustic duct assembly 200 comprising a first acoustic duct 30 and an acoustic duct connector 10. The perspective view clearly shows the annular shape of the first surface portion 3 being that of a first magnetical component 7. The first acoustic duct 4 is of circular shape and coaxially aligned with the first surface portion 3.

A minimum configuration of an acoustic duct coupling 100 is shown in FIG. 3. A housing 9 connects a first magnetical component 7 to a first acoustic duct 30. The housing 9 is fitted to an inner diameter of the first acoustic duct 30. A receiving connector 20 is merely constituted by a second magnetical component 8.

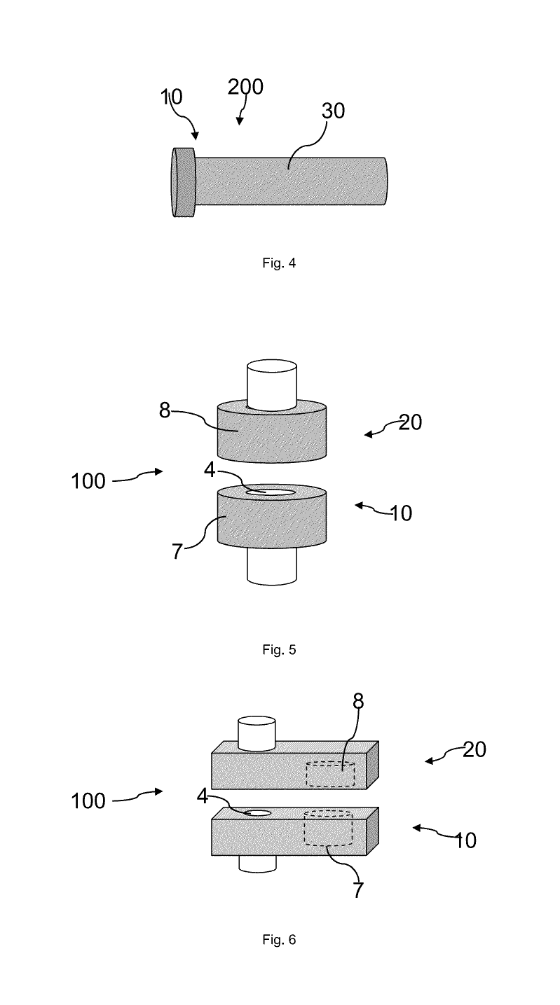

FIG. 4 shows a tube assembly 200 comprising the tube connector 10 and the first acoustic duct 30 described with respect to FIG. 3.

Position arrangements of the first and second magnetical component 7, 8 are apparent from FIG. 5 and FIG. 6 both showing an acoustic duct coupling 100 comprising an acoustic duct connector 10 and a receiving connector 20. Both figures show a respective acoustic duct 10 being constructed identical to a corresponding receiving connector 20. A first magnetical component 7 in FIG. 5 is provided as a ring magnet, wherein a first acoustic duct 4 passed through the centre of the ring magnet. In FIG. 6 on the other hand the first magnetical component 7 is located next to the first acoustic duct 4 and the second magnetical component 8 is located next to the second acoustic duct 6 (not shown).

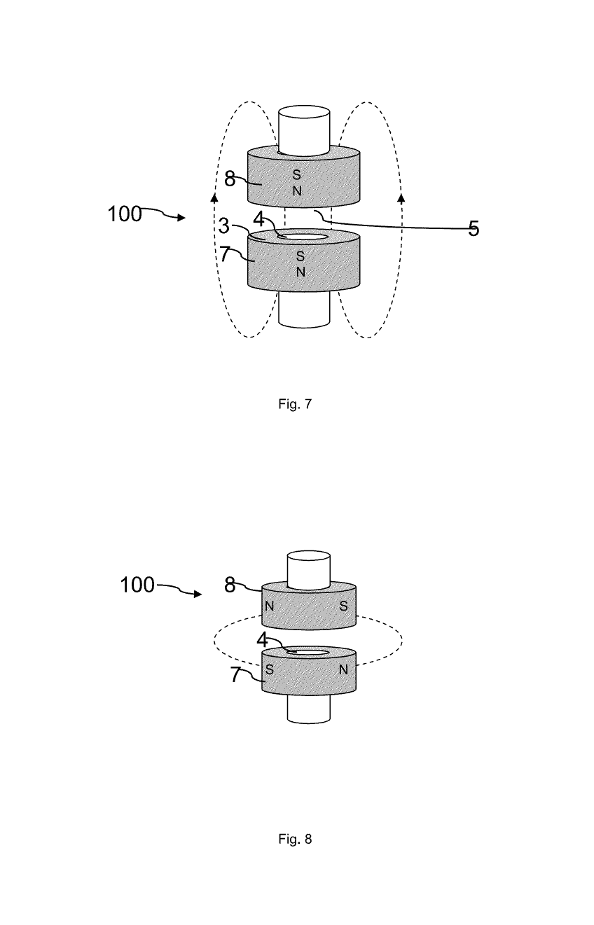

In an acoustic duct coupling 100 in FIG. 7 both the first magnetical component 7 and the second magnetical component 8 are permanently magnetized axially with respect to an axis normal to their respective first and second surface portion 3, 5. In an acoustic duct coupling 100 in FIG. 8 both the first magnetical component 7 and the second magnetical component 8 are permanently magnetized radially with respect to an axis normal to their respective first and second surface portion 3, 5.

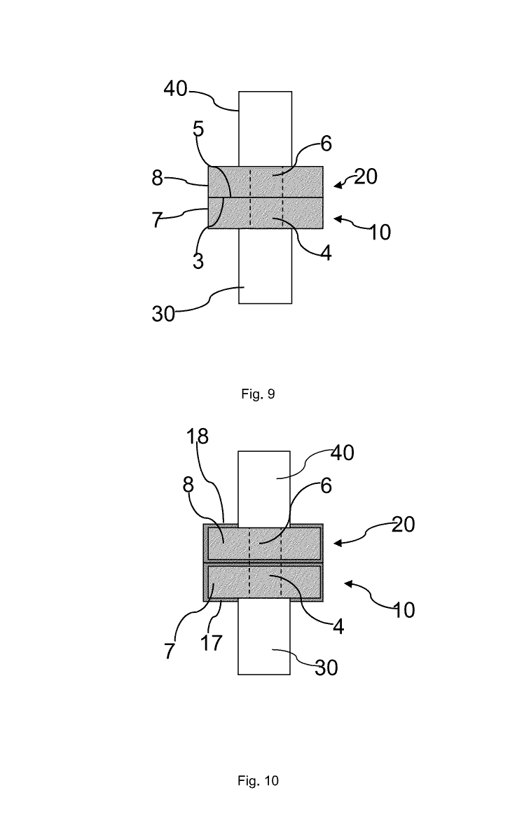

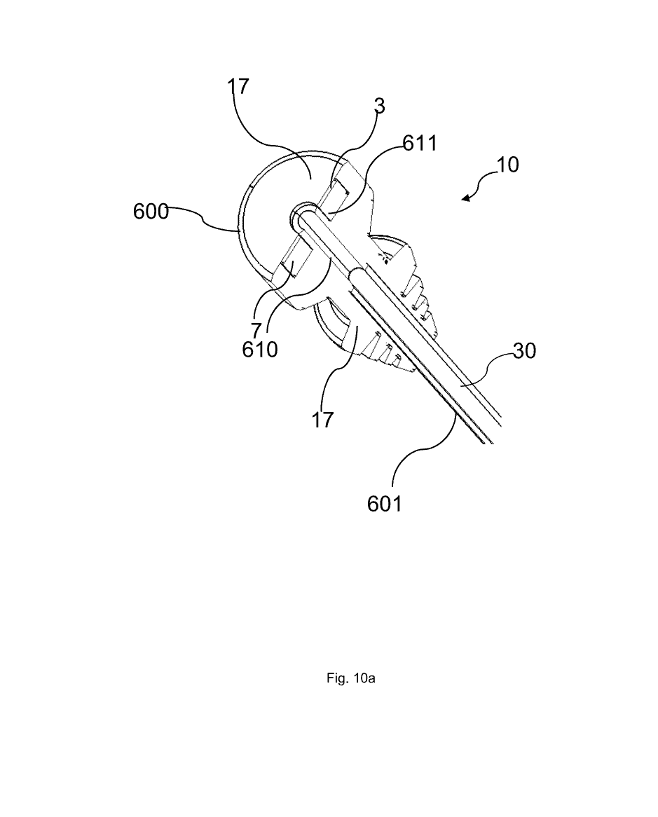

Three concepts of sealing an acoustic duct connector 10 against a receiving connector 20 are shown in FIG. 9, FIG. 10 and FIG. 11. The first surface portion 3 and the second surface portion 5 in FIG. 9 are smooth. In FIG. 10 the first magnetical component 7 and the second magnetical component 8, including their respective surface portions 3 and 5, are coated with a respective sealing member 17 and 18 made of silicone or other gasket material such as rubber or flexible polymer. Shown in FIG. 11 is a first sealing member 17 located on the first surface portion 3 and alongside the first magnetical component 7 and second sealing member 18 located on the second surface portion 5 and alongside the second magnetical component 8. The first housing 9 is adapted to house the first sealing member 17 as well as the first magnetical component 7, wherein the second housing 11 is adapted to house the second sealing member 18 as well as the second magnetical component 8.

FIG. 10a shows an acoustic duct coupling with the magnet, tube and overmould in a sectional view in 3D projection. The sealing member 17 is provided as an overmould which covers both the end of the sound duct 30 and the magnet 7. The magnet surface 3, which is to couple to a similar further magnet (not seen in FIG. 10a) is also covered with a thin layer of the sealing material in the overmould process. The surface above the magnet 3 is even and flat all the way to the edge 600 of the housing of the acoustic duct connector 10. The conduct 30 comprises a flexible tube 601, a conduct 610 through the sealing member 17 and a canal 611 through the magnet 7. The canal 611 and conduct 610 are axially aligned and perpendicular to the plane of the coupling surface.

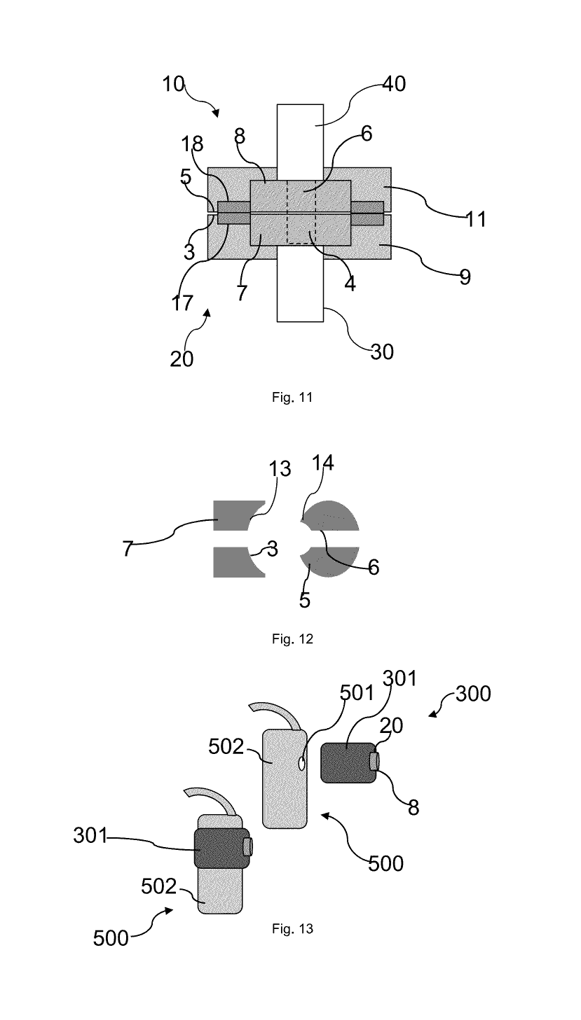

FIG. 12 shows a first magnetical component 7 and a corresponding second magnetical component 8. The first surface portion 3 is of a concave calotte shape and the second surface portion 5 is of a convex spherical shape 5 complementary to the calotte shape. The second acoustic duct 6 exiting from the spherically shaped second surface portion 5 comprises a recess 6′. Because of its shape the first surface portion 3 is coincidently the first guiding member 13, wherein the second surface portion 6 is coincidently the second guiding member 14.

FIG. 13 shows a hearing aid adapter 300 for coupling an acoustic duct 30 (not shown) to a microphone inlet 501 of a BTE-hearing aid 500. The hearing aid adapter 300 comprises a sleeve 301 adapted to be arranged around a housing 502 of the BTE-hearing aid 500. The hearing aid adapter further comprising receiving connector 20 which is constituted by a second magnetical component 8 having an annular shape. When the sleeve 301 is wrapped around the housing 502, an airborne acoustical signal entering the receiving connector 20 can propagate into the microphone inlet 501.

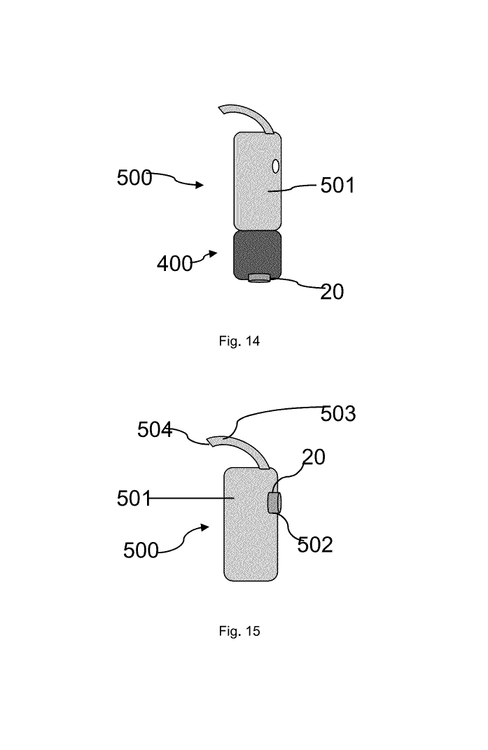

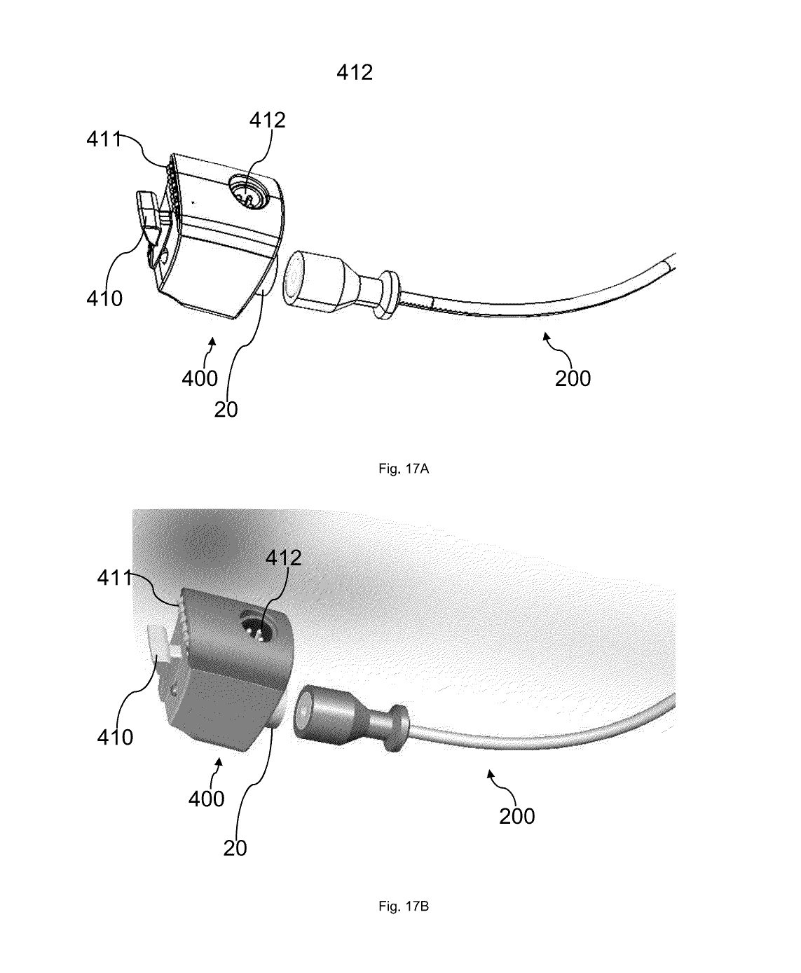

An RECD-programming component 400 is shown in FIG. 14. The RECD-programming component 400, which is adapted to be releasably connected to a housing 501 of a BTE-hearing aid 500, comprises a receiving connector 20 and an internal microphone 401 (seen in FIG. 16). The receiving connector 20 is acoustically connected to said internal microphone 401 so as to allow for an airborne sound signal entering the receiving connector 20 to propagate to the microphone 401.

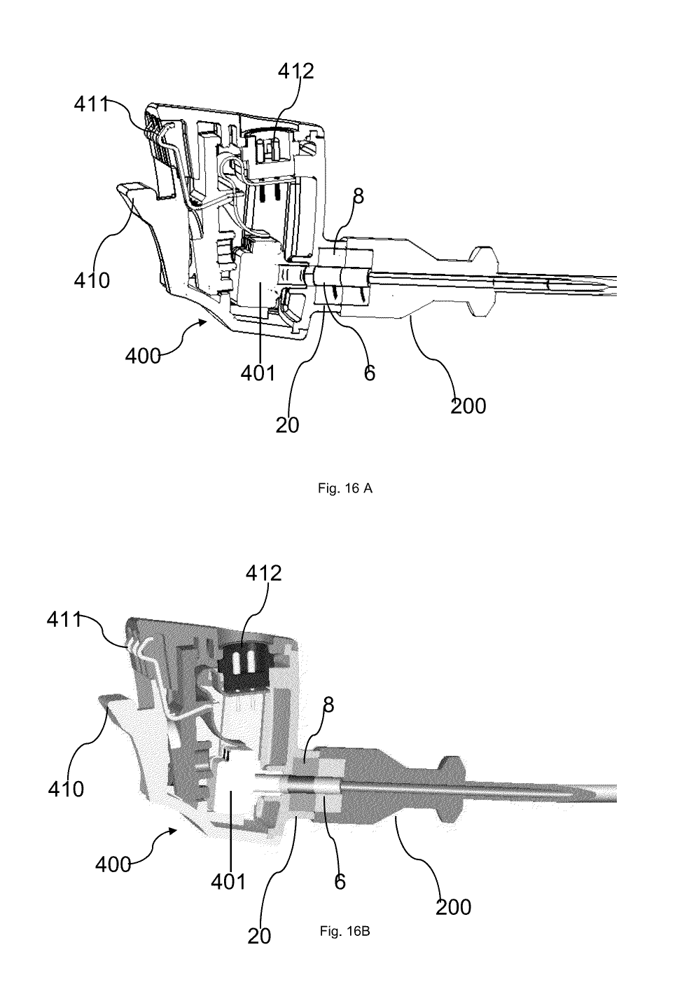

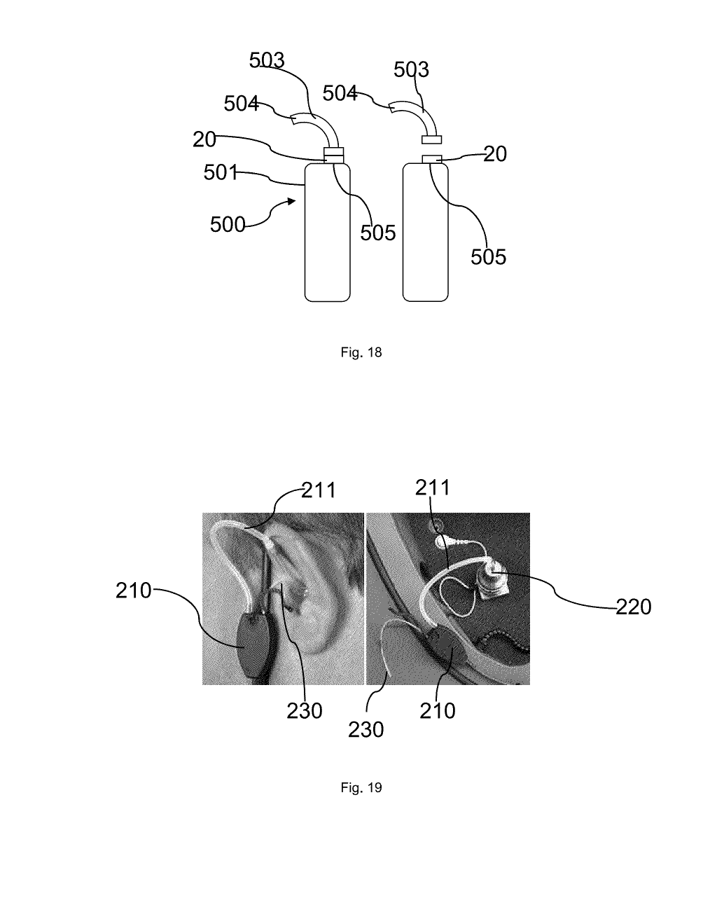

BTE-hearing aid 500 in FIG. 15 comprises a housing 501 having a microphone inlet 502, and comprising a hook 503 having a receiver outlet 504, wherein the BTE-hearing aid 500 further comprises a receiving connector 20 being arranged around the microphone inlet 502. Optionally or additionally the BTE-hearing aid 500 can comprise a receiving connector being arranged at the receiver outlet 504 and/or at a sound outlet 505 of the housing 501 such as shown in FIG. 18. With this arrangement it is now possible easily change the hook 503 or if a connector is provided at the sound outlet 504, the tubing to the in the ear mould or other earpiece may be changed without any fumbling with these small part. A similar arrangement is illustrated in FIG. 18.

FIG. 16 shows in more detail an internal view of RECD-programming component 400, which comprises a receiving connector 20 and an internal microphone 401. The receiving connector 20 is constituted by a second magnetical component 8. The second magnetical component 8 is provided having an annular shape and a second acoustic duct 6 at its centre such, as for example the second magnetical component 8 in FIG. 9. The receiving connector 20 is acoustically connected to the internal microphone 401. Connected to the receiving connector 20 is an acoustic duct assembly 200 such as the one depicted in FIG. 2.

FIGS. 17 and 17A shows an external view of the RECD-programming component 400 described with respect to FIG. 16 and an acoustic duct assembly 200 such as the one depicted in FIG. 2 in close proximity. The RECD component 400 will be attached to a hearing aid 500 as shown in FIG. 14. To this end the component 400 comprise both a mechanical grip element 410 and electrical connection points 411, which are shaped to allow mechanical and electrical connection with the hearing aid in question and may thus be shaped in many different ways depending on the corresponding connection means on the hearing aid (not shown). The component also comprises electrical connection points 412 adapted to receive a jack connector of a type usual in the hearing aid business, such that the hearing aid and component 400 may be connected to an external device such as a computer. When the component 400 is seated on a hearing aid, a jack is plugged into the socket 412 for connecting the hearing aid to a computer through the component 400, the hearing aid may be commanded by the computer to feed sound into the ear of a hearing aid user wearing the hearing aid. If at the same time the tube and connector 200 is attached to the connector 20 the sound tube may be placed inside the users ear canal and thereby the microphone 401 will be able to monitor the sounds inside the ear canal produced by the hearing aid. This allows a hearing care professional to verify the sound pressure provided by the hearing aid, which again allows a better and more secure tuning of the hearing aid.

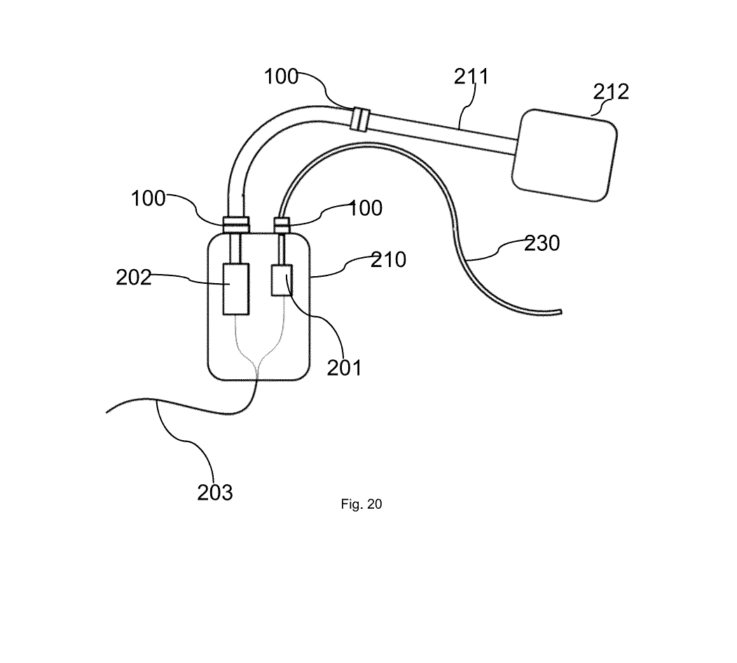

In other forms of audiological gear such as shown in FIG. 19 and schematically in FIG. 20 also one or more detachably mounted sound tubes may be called for. In FIG. 20 the following components are schematically shown: Acoustic duct coupling 100, microphone 201, receiver 202, electric wire 203, housing for REM transducers 210, ear mould tubing 211, earmold 212, probe tube 230. The equipment is used for a variety of real ear measurements, like open ear response, occluded ear response, Real Ear to Coupler difference and audiogram. The equipment allow the hearing care professional to emit sound via the build in receiver 202 into the ear canal with the users own mould 212 or a instant ear mould. The equipment also allow the hearing care professional to attach a probe tube 230 (via the magnetic acoustic duct coupling 100) and place the probe tube in the users ear canal, and measure the resulting sound pressure level. Alternatively the ear mould may be tested in a standard coupler 220 as seen in FIG. 19 at the left side or in a users ear as shown in the right hand side.

1. Acoustical duct connector for an acoustical duct comprising a first surface portion and a first acoustic duct exiting from said first surface portion, and comprising a first magnetical component for engaging to a second magnetical component comprised by a receiving connector such, that an airborne sound signal can propagate from the first acoustic duct to a second acoustic duct exiting from a second surface portion of the receiving connector when the connector is connected to a corresponding receiving connector.

2. Acoustical duct coupling for an acoustical duct, comprising a connector with a first surface portion and a first acoustic duct exiting from said first surface portion, and a receiving connector with a second magnetical component, a second surface portion and a second acoustic duct exiting from said second surface portion, wherein the connector comprises a first magnetical component for engaging to the second magnetical component such, that an airborne sound signal can propagate through the first and the second acoustic ducts when the acoustic duct connector and the receiving connector are connected to each other.

3. Acoustical duct coupling according to claim 2, wherein the first surface portion is that of the first magnetical component and/or the second surface portion is that of the second magnetical component.

4. Acoustical duct coupling according to claim 2, wherein the first and the second surface portion have congruent annular cross sections coaxially aligned with their respective acoustic ducts.

5. Acoustical duct coupling according to claim 2, wherein the first and/or the second magnetical component is magnetized axially or diametrically with respect to an axis normal to their respective first and second surface portion.

6. Acoustical duct coupling according to claim 2, wherein the first or the second magnetical component are non-magnetized.

7. Acoustical duct coupling according to claim 2, comprises a housing circumferentially enclosing the first magnetical component and/or wherein the receiving connector comprises a housing circumferentially enclosing the second magnetical component.

8. Acoustical duct coupling according to claim 2, wherein the first surface portion and the second surface portion are smooth and/or covered with a respective sealing member.

9. Acoustical duct coupling according to claim 2, wherein the acoustic duct connector and the receiving connector each comprise a respective sealing member, wherein a first sealing member is located on the first surface portion and alongside the first magnetical component and the second sealing member is located on the second surface portion and alongside the second magnetical component.

10. Acoustical duct coupling according to claim 2, comprising a first guiding member located at the first surface portion and the receiving connector comprises a second guiding member located at the second surface portion, said second guiding member matching the first guiding member, the guiding members preferably being provided as complementary bevelled rims arranged around their respective surface portion.

11. Acoustical duct coupling according to claim 2, wherein the connector is connected to a first acoustical duct and/or the receiving connector is connected to a second acoustical duct.

12. Acoustical duct assembly comprising an acoustical duct of the type being used for real ear measurements and an acoustical duct connector according to claim 1 attached thereto.

13. Hearing aid adapter for coupling an acoustical duct to a microphone inlet or a receiver outlet of a BTE-hearing aid, the hearing aid adapter comprising a sleeve adapted to be arranged around a housing of a BTE-hearing aid and further comprising an acoustical duct connector according to claim 2.

14. RECD-programming component adapted to be releasably connected to a housing of a BTE-hearing aid, the RECD-programming component comprising an acoustical duct coupling according to claim 2 and a microphone, wherein the receiving connector is acoustically connected to the microphone so as to allow for an airborne sound signal entering the receiving connector to propagate to the microphone.

15. BTE-hearing aid comprising a housing having a microphone inlet, and comprising a hook having a receiver outlet, wherein the BTE-hearing aid further comprises an acoustical duct coupling according to claim 2, the coupling being arranged around the microphone inlet and/or the receiver outlet of BTE-hearing aid.

16. Acoustical duct coupling according to claim 3, wherein the first and the second surface portion have congruent annular cross sections coaxially aligned with their respective acoustic ducts.

17. Acoustical duct coupling according to claim 3, wherein the first and/or the second magnetical component is magnetized axially or diametrically with respect to an axis normal to their respective first and second surface portion.

18. Acoustical duct coupling according to claim 4, wherein the first and/or the second magnetical component is magnetized axially or diametrically with respect to an axis normal to their respective first and second surface portion.

19. Acoustical duct coupling according to claim 3, wherein the first or the second magnetical component are non-magnetized.

20. Acoustical duct coupling according to claim 4, wherein the first or the second magnetical component are non-magnetized.
